(19) United States
(12) Patent Application Publication
(10) Pub. No.: US 2025/0091161 A1
(43) Pub. Date: Mar. 20, 2025

(54) SINGLE-STEP LASER CUTTING AND PRE-WELDING OF A METAL FOIL STACK

(71) Applicant: Coherent, Inc., Santa Clara, CA (US)

(72) Inventors: Majid ABBASI, Houston, TX (US); Farzad VAKILI, Rüfenacht BE (CH)

(73) Assignee: Coherent, Inc., Santa Clara, CA (US)

(21) Appl. No.: 18/882,175

(22) Filed: Sep. 11, 2024

Related U.S. Application Data
(60) Provisional application No. 63/538,553, filed on Sep. 15, 2023.

(51) Int. Cl. B23K 26/21; B23K 28/02; B23K 37/04; B23K 101/38

(52) U.S. Cl. CPC B23K 26/21; B23K 28/02; B23K 37/0435; B23K 2101/38

(57) ABSTRACT

A method laser cuts and laser pre-welds a stack of metal foils in a single laser process. The method includes clamping together the stack of metal foils, and irradiating the clamped stack with a laser beam to complete a cut through the entire stack and, while cutting the stack, form a weld joint joining the metal foils together at the cut. Subsequently, the cut and pre-welded stack of metal foils may be laser welded to a metal substrate that is significantly thicker than individual foils. The method may be applied to stacks of anode and cathode foils in electrochemical batteries, such as lithium-ion batteries.

### CROSS-REFERENCE TO RELATED APPLICATION

This application claims the benefit of U.S. Provisional Application No. 63/538,553, filed Sep. 15, 2023, the entire contents of which is incorporated herein by reference.

### TECHNICAL FIELD OF THE INVENTION

The present invention relates in general to preparing a stack of metal foils for laser welding to a metal substrate, in particular as applied to the production of electrochemical batteries such as lithium-ion batteries.

### DISCUSSION OF BACKGROUND ART

There is a strong push towards carbon-emission-free transportation. This effort involves phasing out the large existing fleet of diesel- and gasoline-powered vehicles and replacing these vehicles with electric vehicles. Efficient and reliable lithium-ion batteries and cost-effective production thereof are paramount to the success of this effort.

The basic unit of a lithium-ion battery cell consists of an anode, a cathode, and a separator therebetween. The separator is infused with an electrolyte containing lithium salt. Each of the anode and the cathode includes a current collector in the form of a metal foil. Typically, the metal foil of the anode is made of copper, and the metal foil of the cathode is made of aluminum. Some types of lithium-ion battery cells contain only a single basic unit, while others contain multiple basic units coupled in parallel. In applications requiring high storage capacity, it is common to couple together multiple lithium-ion battery cells in series and/or parallel. For example, a battery pack for an electric vehicle contains multiple battery modules, each containing multiple lithium-ion battery cells. Particularly for electric vehicles, the objective is to achieve the highest possible energy storage capacity per volume and per weight, while ensuring reliability and keeping the manufacturing cost at an acceptable level.

Lithium-ion battery cells are being manufactured in three different cell-formats: cylindrical, prismatic, and pouch. In a cylindrical cell, a single basic unit (anode, cathode, and separator) is wound in a jelly-roll fashion and disposed in a rigid metal cylinder. The cylindrical cell is the original format used for lithium-ion batteries, but the cylindrical shape precludes efficient packaging of multiple battery cells in a battery module. The prismatic cell shape is better suited to applications, such as electric vehicles, that require many battery cells and a high energy density. Pouch cells provide further improvement in terms of achievable energy density, both per volume and per weight. Whereas a prismatic cell has a rigid metal casing similar to that of a cylindrical cell, the casing of the pouch cell is a soft polymer-coated aluminum foil that is both thinner and lighter than the rigid metal casings of prismatic and cylindrical cells.

Some prismatic cells contain a single, basic lithium-ion battery unit wound or folded in a flatter shape than that used in cylindrical cells. Other prismatic cells and most pouch cells contain multiple basic units stacked on each other and electrically coupled in parallel. These stacked-structure cells contain many layers organized in the general configuration anode, separator, cathode, separator, anode, separator, and so on. Instead of using multiple independent separator layers, a single separator strip may be folded in a Z-fashion between the multiple anode and cathode layers. Comparing winding of a single basic unit to stacking of multiple basic units, the winding process is simpler and faster than the stacking process. However, the stacked structure has several advantages including higher energy density, faster charging and discharging, and greater flexibility in terms of the overall shape of the battery cell.

In a stacked-structure cell, the current-collecting metal foils of all anodes and cathodes protrude from the side(s) of the multilayer structure. The current-collecting metal foils of all the cathodes form a foil stack that is welded to a metal tab, and the current-collecting metal foils of all the anodes form another foil stack that is welded to another metal tab. It is common to have 20-40 foils in each stack. The thickness of each individual foil is usually between approximately 5 and 30 micrometers (μm). The tab thickness usually exceeds the foil thickness by a factor of about ten or more.

The mechanical attachment and electrical connection of each foil to the respective tab is critical for the integrity, reliability, and performance of batteries based on stacked-structure cell design. However, joining many thin metal foils to a much thicker metal tab is challenging. The completed joint must be strong, durable, and have low electrical resistance. Ultrasonic welding is the most widely used welding technique. In one existing technique, the foils are first welded together using ultrasonic welding to strengthen the structure of the foil stack. Next, the pre-welded foil stack is welded to the tab in a second ultrasonic welding step. This second ultrasonic welding step benefits from the strengthened structure provided by pre-welding.

### SUMMARY OF THE INVENTION

Laser welding is an attractive alternative to ultrasonic welding for joining the foil stack to the tab. As compared to ultrasonic welding, laser welding provides more precise power delivery and minimizes overall heat accumulation. Additionally, the high laser intensity vaporizes contaminants, unlike in ultrasonic welding where such contaminants may compromise the integrity of the welded structure.

Laser welding of a metal foil stack to a metal tab, as applied to the production of a lithium-ion battery cell, may entail irradiating the edge of the foil stack, where the foils terminate, with a laser beam. The laser irradiation process forms a weld joint that welds the edge of the foil stack to the tab. The foils are cut before welding of the stack to the tab so as to form a straight stack-edge, where each individual foil extends to the edge and therefore is included in the stack-to-tab welding process. Due to the substantial thickness of the tab, the stack-to-tab welding process requires depositing a relatively large amount of laser energy onto the assembly, including onto the metal foils. The potential exists for individual foils responding to the laser energy in undesirable ways. For example, substantial amounts of material may be lost through spatter (e.g., ejection of material droplets), or foils may curl. The risk of such issues occurring may be reduced by pre-welding the foils together at the stack-edge before initiating the stack-to-tab welding process. Unlike the stack-to-tab welding process, the pre-welding process can be optimized specifically for the properties of the foils, particularly their lesser thickness of only, e.g., 5-30 μm. Thus, a complete and fully laser-based technique for joining the foils and the tab may include laser cutting the stack to form a regular stack-edge, laser pre-welding the stack-edge, and subsequently laser welding the foil stack to the tab.

Disclosed herein is a laser-based method that cuts and pre-welds the foil stack in a single, common process step. The foil stack is irradiated by a laser beam that cuts the stack to form a regular stack-edge while welding together the ends of the foils at the stack-edge. By combining the cutting and pre-welding processes, the presently disclosed method facilitates joining of the foil stack and tab in a total of just two process steps, as opposed to three or more. The present method is useful in lithium-ion battery production, as well as more generally applicable to cutting and edge-welding of a stack of metal foils.

In one aspect of the invention, a method for laser cutting and laser pre-welding a stack of metal foils includes (a) clamping together the stack of metal foils, and (b) irradiating the stack, as clamped, with a laser beam to complete a cut through the entire stack and form a weld joint joining the metal foils together at the cut.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates, in cross-sectional view, a method for laser cutting and laser pre-welding a stack of metal foils in a single step, according to an embodiment.

FIG. 2 is a top-view of the metal foil stack as clamped during the method of FIG. 1.

FIG. 3 illustrates laser irradiation of the metal foil stack in the method of FIG. 1.

FIG. 4 illustrates an outcome of the method of FIG. 1.

FIG. 5 illustrates a method for laser welding the metal foil stack to a metal substrate after completion of cutting and pre-welding of the foil stack according to the method of FIG. 1, according to an embodiment.

### DETAILED DESCRIPTION OF THE INVENTION

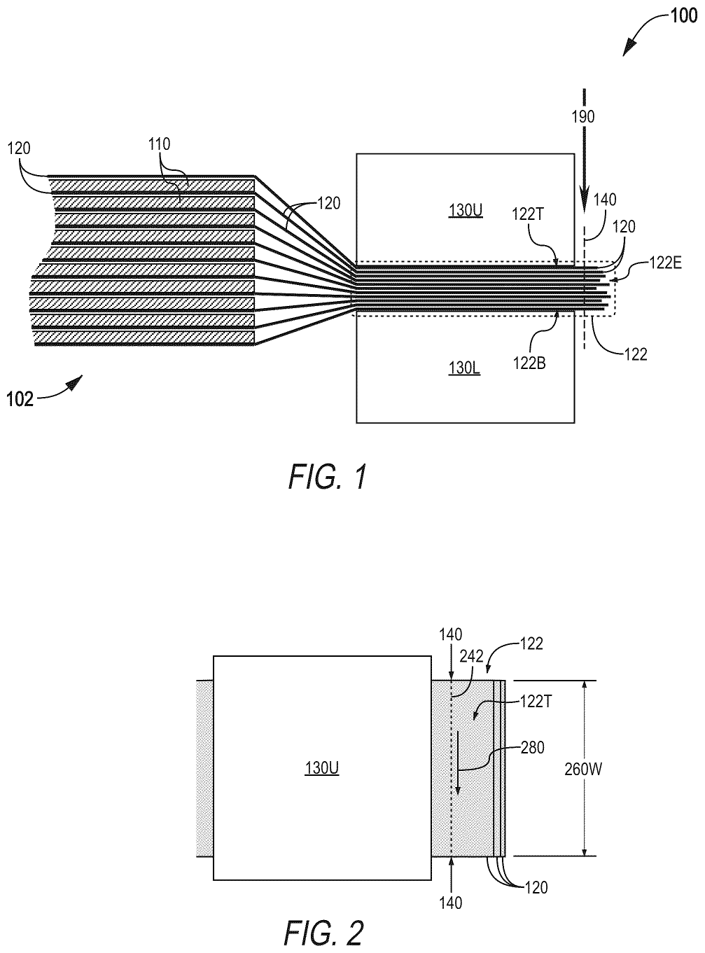

Referring now to the drawings, wherein like components are designated by like numerals, FIG. 1 illustrates one method 100 for laser cutting and laser pre-welding a stack 122 of metal foils 120 in a single step. FIG. 1 provides a cross-sectional view of foil stack 122, in an exemplary scenario where foils 120 are current-collecting anode or cathode foils of a lithium-ion battery cell 102. Method 100 is not limited to this scenario. Rather, method 100 is generally applicable to cutting and edge-welding of stacks of metal foils.

In battery cell 102, foils 120 are separated by material layers 110. In one example, foils 120 are current-collectors of cathodes of battery cell 102, and each layer 110 includes two separators and an anode. In this example, each foil 120 may be made of aluminum. In another example, foils 120 are current-collectors of anodes of battery cell 102, and each layer 110 includes two separators and a cathode. In this example, each foil 120 may be made of copper. While FIG. 1 only shows one stack 122 of foils 120 to be welded to substrate 130, battery cell 102 may include two stacks 122 of foils 120, each to be welded to a respective substrate 130 using method 100. One of these stacks includes current-collecting foils of anodes of battery cell 102, and the other stack includes current-collecting foils of cathodes of battery cell 102. Battery cell 102 may be a prismatic cell or a pouch cell.

More generally, the material of foils 120 may be selected from the group consisting of copper, aluminum, nickel, lithium, sodium, calcium, magnesium, iron, zinc, and their bimetals. The thickness of each foil 120 may be less than 50 micrometers (μm), for example in the range between 1 and 50 μm or in the range between 5 and 30 μm. In one scenario, the number of foils 120 in foil stack 122 is in the range between 10 and 200.

Method 100 clamps foil stack 122 to limit the mobility of individual foils 120. In the depicted embodiment, foil stack 122 is clamped between (a) an upper clamp 130U in contact with a top-surface 122T of foil stack 122 and (b) a lower clamp 130L in contact with a bottom-surface 122B of foil stack 122. Foil stack 122 and an edge 122E thereof protrude from clamps 130U and 130L to allow a laser beam 190 access to top-surface 122T. In some embodiments, other techniques for physically securing foils 120 together, aside from or in addition to clamping, may be used.

Method 100 scans laser beam 190 along top-surface 122T to make a cut 140 through the entire height of foil stack 122 from top-surface 122T to bottom-surface 122B. Laser beam 190 may be infrared, visible, or ultraviolet. Laser beam 190 may be continuous-wave, or pulsed or otherwise temporally modulated. The location of cut 140 is indicated in FIG. 1 by a dashed line that, for clarity, extends beyond both top-surface 122T and bottom-surface 122B. In an alternative embodiment, not shown in FIG. 1, lower clamp 130L extends beyond stack edge 122E or at least beyond the location of cut 140. In this alternative embodiment, care must be taken to not inadvertently weld foil stack 122 to lower clamp 130L. In the following, it is assumed that foil stack 122 and edge 122E protrude from both clamp 130U and clamp 130L.

FIG. 2 is a top-view of foil stack 122 as clamped during method 100. FIGS. 1 and 2 are best viewed together. In FIG. 2, the location of cut 140 is indicated by two opposing arrows. A path 242 on top-surface 122T coincides with cut 140. Cut 140 and path 242 span the entire width 260W of foil stack 122. In one example, width 260W is in the range between 20 and 100 millimeters.

As shown in both FIGS. 1 and 2, the edge 122E of foil stack 122 is initially uneven. Cut 140, when executed by laser beam 190, trims foils 120 to form a straight stack edge. In the depicted example, cut 140 is planar and orthogonal to foils 120, and the corresponding path 242 on top-surface 122T is linear. In another example, cut 140 is at an oblique angle to foils 120 and/or curved in the dimensions parallel to foils 120. Method 100 may produce cut 140 by tracing path 242 on top-surface 122T, for example as indicated by arrow 280 in FIG. 2. Optionally, method 100 utilizes an assist gas, e.g., nitrogen.

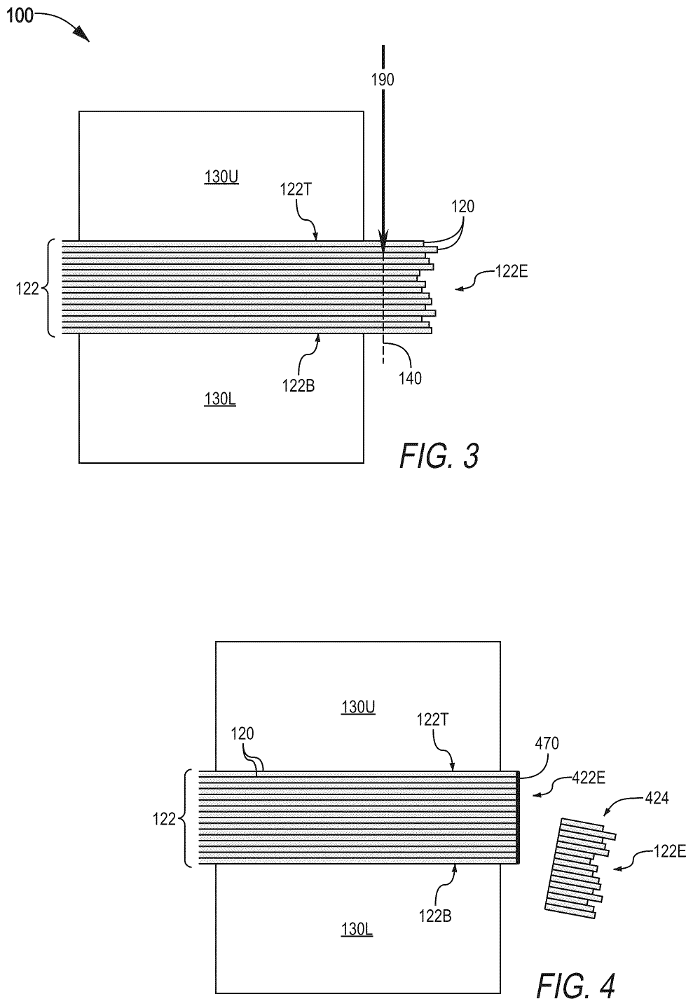

FIGS. 3 and 4 are cross sectional views of foil stack 122, as clamped, that illustrate aspects of method 100 in further detail. As shown in FIG. 3, laser beam 190 penetrates into foil stack 122 from top-surface 122T and ultimately through foil stack 122 to complete cut 140. Foil stack 122 may be positioned at a focus of laser beam 190. The Rayleigh range of laser beam 190 is usually significantly greater than the height of foil stack 122. Laser beam 190 may trace path 242 on top-surface 122T along the intended location of cut 140, for example as indicated by arrow 280 in FIG. 2. In one implementation, laser beam 190 completes cut 140 in a single pass along path 242. In another implementation, laser beam 190 makes multiple passes, e.g., between 2 and 15 passes or up to 100 passes, along path 242 before completing cut 140. In this multi-pass implementation, one or more initial passes may cut only partway through the height of foil stack 122.

As laser beam 190 cuts through foil stack 122, laser beam 190 also melts the ends of foils 120 at the newly formed stack edge 422E to form a weld joint 470, as shown in FIG. 4. Weld joint 470 joins all foils 120 at stack edge 422E. The completion of cut 140 results in the newly formed stack edge 422E of foil stack 122 being straight. Cut 140 cuts off a portion 424 with the uneven edge 122E. Cut-off portion 424 may be in a single piece due to welding by laser beam 190, or in multiple pieces.

The number of passes needed (or used) to complete cut 140 and pre-weld the newly formed straight edge 422E may depend on several parameters including (a) the material, thickness, and/or number of foils 120 and (b) laser beam parameters such as power, beam size, and/or the rate of movement along path 242. The laser beam parameters may be selected to ensure formation of weld joint 470 without compromising the integrity of foils 120 (or at least while minimizing deformation/damage to foils 120). In scenarios where the cut and pre-welded foil stack 122 is to be subsequently welded to a substrate, e.g., a tab of a lithium-ion battery, it may also be preferred that weld joint 470 does not form a substantial bead. Depending on its size and position, a substantial weld bead may prevent good contact between foil stack 122 and the substrate. In one example, the thickness of weld joint 470 orthogonally to stack edge 422E is less than 100 μm. In the dimension along stack edge 422E, the maximum extent of weld joint 470 beyond at least one of top-surface 122T and bottom-surface 122B may be less than twice the thickness of individual foils 120.

Many applications further impose an upper limit on the time required to complete method 100, enabling meeting requirements for efficient production of a lithium-ion battery.

Successful cutting and pre-welding outcomes have been demonstrated both with and without assist gas. An embodiment of method 100 utilizing multiple passes along path 242 and no assist gas has proven particularly advantageous for preparing the foil stack for subsequent welding to a substrate. In one example of method 100, the power of laser beam 190 is in the range between 0.5 and 2.5 kilowatts. The diameter of laser beam 190 at foil stack 122 may be between 10 and 100 μm. The rate of movement of laser beam 190 along path 242 may be in the range between 100 and 8000 millimeters/second.

Certain embodiments of method 100 include wobbling laser beam 190 while tracing path 242. For example, while laser beam 190 is generally moved along path 242, the exact location of incidence of laser beam 190 on top-surface 122T is steered to orbit around a center point that traces path 242. The wobbling frequency may be up to 4 kilohertz, and the width of the region irradiated by laser beam 190 along path 242 may be up to 500 μm.

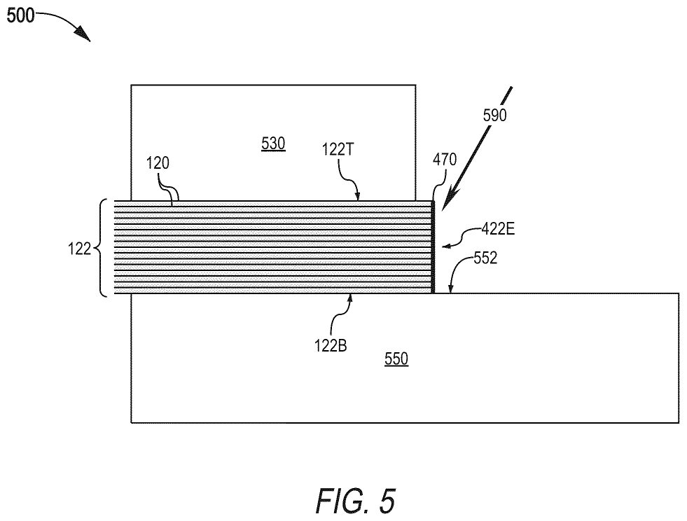

FIG. 5 illustrates one method 500 for laser welding foil stack 122 to a metal substrate 550 after completion of cutting and pre-welding of foil stack 122 according to method 100. Substrate 550 is, for example, a metal tab of an electrochemical battery. The electrochemical battery may be a lithium-ion battery. However, method 500 is also applicable to electrochemical batteries based on another types of ions than lithium, for example sodium, magnesium, calcium, aluminum, iron, and/or zinc. Substrate 550 is significantly thicker than individual foils 120, e.g., by one or several orders of magnitude. In one example, the thickness of substrate 550 is at least 300 μm.

From a laser-welding perspective, it may be preferred that foils 120 and substrate 550 are made of the same material. Thus, in one embodiment, substrate 550 is of the same material as foils 120. For example, substrate 550 may be made of aluminum when foils 120 are made of aluminum, and substrate 550 may be made of copper when foils 120 are made of copper. However, for example when foils 120 and substrate 550 are part of battery cell 102, weight considerations may be more important. Thus, substrate 550 may be made of another material than foils 120. For example, substrate 550 may be made of aluminum even if foils 120 are made of another material, e.g., copper.

In method 500, foil stack 122 is disposed on a surface 552 of substrate 550. Substrate 550 or at least surface 552 may be planar, with foils 120 being generally parallel to surface 552. Foil stack 122 may be arranged such that bottom surface 122B is in contact with surface 552, as shown in FIG. 5. Alternatively, the orientation of foil stack 122 is flipped such that top surface 122T is in contact with surface 552. In one embodiment, foil stack 122 is clamped against substrate 550 using an upper clamp 530. Substrate 550 may function as a lower clamp, or foil stack 122 and substrate 550 may be clamped together between upper clamp 530 and a lower clamp not shown in FIG. 5.

A laser beam 590 welds foil stack 122 to substrate 550. Typically, laser beam 590 is incident on stack edge 422E, primarily. However, laser beam 590 may also irradiate the surface of foil stack 122 facing away from substrate 550 (top-surface 122T in the depicted embodiment) near stack edge 422E.

The present invention is described above in terms of a preferred embodiment and other embodiments. The invention is not limited, however, to the embodiments described and depicted herein. Rather, the invention is limited only by the claims appended hereto.

What is claimed is:

1. A method for laser cutting and laser pre-welding a stack of metal foils, comprising steps of:
clamping together the stack of metal foils; and
irradiating the stack, as clamped, with a laser beam to complete a cut through the entire stack and form a weld joint joining the metal foils together at the cut.

2. The method of claim 1, wherein the weld joint joins together all metal foils of the stack.

3. The method of claim 1, wherein the step of irradiating includes tracing a path on a top-most metal foil of the stack with the laser beam.

4. The method of claim 3, wherein the step of irradiating cuts the stack and forms the weld joint in a single pass of the laser beam along the path.

5. The method of claim 3, wherein the step of irradiating comprises performing a plurality of passes of the laser beam along the path.

6. The method of claim 1, wherein:
the step of clamping presses the stack between a first clamp in contact with a top-surface of the stack and a second clamp in contact with a bottom-surface of the stack, such that a portion of the stack protrudes from the first and second clamps; and
the cut is through the portion of the stack protruding from the first and second clamps.

7. The method of claim 1, wherein the method uses no assist gas.

8. A method for welding a stack of metal foils to a metal substrate, comprising steps of:
performing the steps of clamping and irradiating of claim 1; and
subsequent to performing the steps of clamping and irradiating, laser welding the stack to the metal substrate.

9. The method of claim 8, further comprising implementing the stack of metal foils and the metal substrate in an electrochemical battery.

10. The method of claim 9, wherein the electrochemical battery is a lithium-ion battery.
